(19) United States
(12) Patent Application Publication
(10) Pub. No.: US 2024/0123894 A1
(43) Pub. Date: Apr. 18, 2024

(54) PUBLIC TRANSPORT VEHICLE FOR THE FLEXIBLE TRANSPORT OF FREIGHT AND/OR PASSENGERS

(71) Applicant: MISSION INNOVATIONS B.V., Eindhoven (NL)

(72) Inventors: Marc Hubert Kerkhofs, EINDHOVEN (NL); Johannes Gertrudis Josephus VAN DER DONK, Best (NL)

(21) Appl. No.: 18/279,158

(22) PCT Filed: Jan. 24, 2022
(86) PCT No.: PCT/NL2022/050032

§ 371 Date: Aug. 28, 2023

(30) Foreign Application Priority Data
Feb. 26, 2021 (NL) 2027659

(51) Int. Cl. B60P 3/42; B60J 5/04; B61D 1/04; B61D 3/00; B61D 19/00; B61D 33/00

(52) U.S. Cl. CPC B60P 3/423; B60J 5/0498; B61D 1/04; B61D 3/005; B61D 19/004; B61D 33/0007

(57) ABSTRACT

The invention relates to a public transport vehicle comprising at least one unit for the flexible transport of passengers and/or freight. According to the invention at least one outer side wall of the unit has multiple adjacent doors, that also form the outer side wall of the vehicle along the length of the vehicle, where when the unit is used for freight transport all doors can open to provide a wide entry opening for loading and unloading freight and when used for passenger transport one or more of the doors remain permanently closed and at least one door can be opened. The inventive vehicle uses a complete outer side wall of the unit as entry and exit possibility. When the unit is meant for transporting freight, all doors in the side wall can open to provide an opening as wide as the length of a unit. The whole space of the unit is than accessible for freight. When using the unit for transporting passengers it is important for safety reasons to keep the doors close to passenger seats permanently closed and locked. At least one door of the unit that is not close to the passenger seats should be able to open to let passengers enter or exit the unit.

The invention relates to a public transport vehicle comprising at least one unit for the flexible transport of passengers or freight. Here public transport means a system of transport, in contrast to private transport, for passengers by group travel, where the public transport system is available for use by the general public. The system is typically managed on a schedule and operated on established routes. Public transport charges a predetermined fee for each trip. Such a vehicle can have several units and have different configurations, depending on the transport of passengers, freight or a combination of freight and passengers. A unit transports either passengers or freight. The conversion from one configuration to another depends on the demand for freight or passengers. Conversion takes place when no freight or passengers are in the unit. Vehicles comprising such units thus provide optimal flexibility for the operators of such vehicles, resulting in an optimal capacity planning and utilization rate.

Such a vehicle is known from U.S. Pat. No. 3,484,002A, where a train is described that has units that can change from passenger to freight transport by using passengers and freight modules that fit in a unit and can be loaded in the train with the help of a crane via the roof of the train.

The known public transport vehicle has the disadvantage that the train is not very flexible. The changing from passenger to freight transport needs a crane and the roof needs to be adapted with hatches that can open and close to allow entry and removal of the modules.

It is the aim of the invention to provide a public transport vehicle with units that are easier and quicker to convert from passenger to freight transport and vice versa.

According to the invention at least one outer side wall of the unit has multiple adjacent doors, that also form the outer side wall of the vehicle along the length of the vehicle, where when the unit is used for freight transport all doors can open to provide a wide entry opening for loading and unloading freight and when used for passenger transport one or more of the doors remain permanently closed and at least one door can be opened. The inventive vehicle uses an outer side wall of the unit as entry and exit possibility, i.e. the doors form the outer sidewall of the unit. Here an outer side wall is the outer wall running along the length of the vehicle (longitudinal direction), i.e. not parallel to the front or the back of the vehicle. The whole side wall of the vehicle at the location of a unit is provided with adjacent doors. When the doors are closed, the adjacent doors are connected together, i.e. their adjacent sides are fixed/locked together. Moreover, preferably the bottom and top of the doors are locked to the unit, so that a very strong and stiff construction is obtained with a very good resistance to impact. When opening the doors the connections between doors can be released if necessary. For instance when more than one door needs to be opened, connections between the doors to be opened can remain locked and only the connections towards doors that should remain closed should be unlocked. Not the whole side wall of the vehicle needs to be provided with units with adjacent doors, since for instance at the front or back of the vehicle, where the driver and/or the engine is located there may be a driver—or engine compartment and no unit, so that there the outer side wall of the vehicle may have a different construction for instance with a single door or hatch. All doors fit together without the use of permanently fixed supporting pillars between the doors. This opens up the possibility for choosing the door configuration of the outer wall, i.e. which doors will open and which ones will remain closed. The adjacent doors are interlocked during travel for safety reasons and to increase the torsional rigidity of the inventive vehicle.

When the unit is meant for transporting freight, all doors in the side wall can open to provide an opening as wide as the length of a unit. The whole space of the unit is than accessible for freight. In that case it is easy to transport a freight module or one or more containers in the open space of the unit. When all doors are open it is also possible to provide a passenger module with chairs, couches, tables or a toilet group in the open space. Preferably the units are integrated in the vehicle, i.e. not separate modules that are moved into or out off of the vehicle. That way a much lighter and cheaper vehicle can be build. Moreover the changeover from freight to passenger transport can be realized much faster.

When using the unit for transporting passengers it is important for safety reasons to keep the doors close to passenger seats permanently closed and locked to prevent persons or their belongings falling out when the vehicle stops or to prevent injuries of persons or their belongings getting stuck between doors. As long as passengers are transported those doors close to passenger seats remain permanently closed and locked. Passengers do not have the authority to unlock these doors unless it's part of an emergency procedure. At least one door of the unit that is not close to the passenger seats should be able to open to let passengers enter or exit the unit.

Of course many variations of the inventive idea are possible. There can be many doors, also of different sizes used in one unit. Doors within a unit can also be separated by removable pillars that act as an extra reinforcement when units need to accommodate heavy loads or when a unit is relatively long. Such removable pillars can then be removed out of the opening when needed, for instance for (un)loading freight. Such removable pillars can be seen as part of a door for extra reinforcement or as a separate door itself, be it a small one.

It is advantageous when more than two units are used, that units for freight (F) are in adjacent units or units for passengers (P) are in adjacent units. This means for instance when there are three units available, configurations should preferably be FFP or PPF. For six units this could be FFPPFF or FFFPPP. This has the advantage that movements of freight and passengers can be separated easily and there is less chance of a passenger getting injured or hindered by loading or unloading of freight.

Several types of doors can be used for the multiple doors of a unit. For instance doors can be of the up and over type (tipped doors) like those used for a garage door. Those doors then slide under or over the roof of the vehicle. In a favorable embodiment the doors are wing doors, also called gullwing or falcon doors. Those doors have hinges at their top, i.e. just under or partially in the roof. The hinge at the top means wing doors remain outside the unit and thus when opened do not need to be stored under or on top of the roof. Wing doors can be constructed in a compact way, for instance by providing them with extra hinges. With wing doors it is also possible to give the vehicle the look of a passenger vehicle. This is preferable, since passengers do not like to use a vehicle that looks like a freight vehicle. For this purpose the wing doors can have windows like a normal passenger vehicle has. The extra hinges can be provided for instance underneath the windows. Then the vehicle looks like a conventional passengers vehicle, but with the added benefit of compact wide opening doors. As an extra benefit wing doors provide coverage against rain when opened. During travel doors are closed and locked. In freight mode, the exterior of the vehicle looks exactly the same as in passenger mode, whereas the interior lacks the seating furniture, creating a flat loading floor for freight that is easily accessible via the side wall of the unit that can be completely opened.

An extra benefit can be obtained if both outer side walls of the unit are provided with the doors. That way loading and unloading of freight and/or passengers can take place even faster. Of course this requires appropriate loading places, like platforms on both sides of the vehicle. In case of passengers this also has the benefit that in case of a pandemic, flows of in- and outgoing passengers do not have to mix, so there is less risk of contamination since passengers do not have to face each other. Such vehicles can also be used as bridges between platforms when doors in both side walls of a unit are opened.

The possibility of creating a wide opening, spanning the whole length of a unit, brings extra construction challenges for the roof, because of the wide open span and the weight of the doors attached to the roof. In a favorable embodiment the unit is provided with a luggage rack that spans the length of the roof and strengthens the construction of the roof of the unit at the side of the doors. This means that the luggage rack is permanently fixed to the roof and its construction is used to add strength to the roof. This way the luggage rack serves two functions, one to store luggage and two to provide strength to the roof. It is also possible to have one or more support structures in a transversal direction in the units between longitudinal luggage racks, for instance under the roof and above freight containers. Such transverse support structures can also function as luggage racks.

When all doors are opened to allow easy access for freight it is advantageous that the unit is reinforced by providing a support structure, where the structure is located in between units or in between a unit and the front or back of the vehicle. Thus such a support structure does not affect the space in the unit, since it is located outside the unit in the space between two units or between the unit and the front or back of the vehicle. The support structure can also be used for accommodating support systems, like providing WiFi, air treatment possibly with bacteria or virus filters, like UVC lamps, or a toilet. The support structure can also be used for storing luggage.

In another inventive embodiment the floor of a unit is divided in checkerboard fields, where each field can comprise a piece of furniture that can be stowed away either in a space between the units, or against the roof or in the floor, so that the top of the floor is free of furniture and practically flat when the furniture is stowed away. Here checkerboard does not mean a literal checkerboard field but the floor comprises flexible fields containing furniture in more or less similar modules. Thus the term checkerboard is used to indicate a flexible, modular stow away construction of furniture configurations. This way no special passenger module is needed. When the unit is used for transporting freight the furniture for passengers is stowed away. That leaves a floor free of furniture and practically flat. The floor can then be used for transporting freight, for instance by placing containers in the unit. The furniture can comprise chairs and tables, where a chair should be interpreted broadly, i.e. it could also mean a couch. The furniture can also comprise waste baskets, beds, or toilet units. In general all furniture used in a vehicle can be used. For larger furniture, like a couch or a toilet unit more than one checkerboard field or a larger field can be used. Tables can be made as tables, but it is also possible to use the backrest of a chair or of more than one chair as a table. Preferably the furniture for each checkerboard field can be individually chosen to be a chair, table or the field can be left free to make different configurations of furniture in the unit possible. That way flexibility is increased even further. For a first class configuration with more space, a row of chairs can be left in the floor for more leg space. It is also possible to provide each chair with a table. In a second class configuration, all chairs can be used. To use the space inside a unit in an optimal way, it is also possible to put a rotation mechanism in each chair so that also back to back configurations of chairs are possible. In case of a pandemic chairs can be separated by one or more tables to make sure that chairs are not located next to each-other and they can be rotated so that passengers do not sit face to face. The furniture can be stowed away in different ways. For instance it can be folded like a camping or beach chair so that the space occupied when folded is small, but it can also remain intact when space is not an issue. The furniture can be stowed away in different places. One example is stowing furniture between units, i.e. in the transverse side walls of units. If there is enough space between units, furniture may not even have to be folded. The conversion from freight to passenger transport can for instance be managed and executed by a management system that measures and manages the demand for freight and passenger transport, so as to use the capacity of the vehicle in an optimal way. It is also possible that furniture is folded and stored in the floor. A third possibility is that the whole floor unit including folded furniture is stowed under the roof of the unit.

To facilitate loading of freight or the entry or exit of passengers it is advantageous if a bottom part of a door can fold downwards to provide a step for easy entry/exit and for covering a gap between a loading platform and the vehicle. This means the bottom part of a door is not connected to the top part of the door, but functions independently of the top of the door. The step in combination with a leveling mechanism of the vehicle results in a horizontally leveled surface between the vehicle and the platform. Such a step is especially useful for passengers using a wheelchair or mobility scooter.

When using a complete vehicle in passenger or freight modus, i.e. all units are either passenger modules or freight modules, there is no problem of a separation between passenger and freight unit. When a vehicle has several units and some are for freight, while others are for passengers it is important to separate the freight and passenger units. This can for instance be done by providing a roller shutter in the roof or floor between units. Preferably for transporting freight, closed containers are used that comprise a side wall that can function as a separation between units with passengers and units with freight. This has several advantages. In a public transport vehicle closed containers, i.e. with all side walls present, are preferable. Of course the container should have a loading door, that can be closed and locked. This means there is no risk of freight falling out and injuring passengers. Moreover the risk of theft or damage to freight by passengers is minimal. The side wall of a container can then also be used to separate passengers in a passenger unit from freight in a freight unit. In that case the separation in the form of roller shutters is not necessary anymore.

Preferably the public transport vehicle is a rail vehicle, like a train, light train or metro, or road vehicle, like a bus. In many cases these forms of public transport are very crowded with passengers during the morning—and evening rush hours during weekdays, but during the rest of a weekday and in weekends only a fraction of the passenger capacity is used. During the rush hours most of the units in such vehicles can be used for transporting passengers. During the off rush hours, conversion of most of the units to transporting freight can take place. That way public transport vehicles can be used much more efficiently resulting in significant higher utilization rates and revenues compared to just public transport of passengers.

This makes it possible to stimulate the use of public transport through numerous quantitative and qualitative impulses such as reducing the fees for public transport or even making it completely free of charge. Moreover, in most cases public transport has a fine-meshed network of rails or of bus lanes that is often exclusively reserved to only them and in general reaches into the heart of crowded cities. If such a network can be used more extensively for the transport of freight as well, this means a significant decrease of trucks and delivery vehicles on roads and in(to) cities which will lead to a significantly reduction of congestions. It is also possible to make public transport to distant isolated villages profitable by combining freight and passenger transport. Moreover public transport vehicles often have electric powertrains, thus further reducing harmful emissions such as CO2, NOx and PM10. In case public transport vehicles have fossil fueled powertrains, the inventive vehicle may initiate and accelerate energy transitions from fossil fueled powertrains to more sustainable electric of hydrogen powertrains because of its significant cashflow abilities resulting from the significant higher utilization rate.

### DESCRIPTION FIGURES

The invention is further explained with the help of the following drawing in which

FIG. 1 shows a view of an outer side wall of a public transport vehicle with four units having different configurations for the doors,

FIGS. 2a, b show a top view of a unit with different configurations of furniture and closed and open doors when the unit is used for transporting passengers,

FIG. 3 shows a transversal cross-section of a vehicle indicating how the space between units is provided with a supporting structure,

FIGS. 4a, b, c shows how a piece of furniture can be folded in the floor,

FIGS. 5a1, a2, b, c show a longitudinal cross section of a vehicle with different configurations for stowing away furniture when the unit is used for transporting freight.

Here longitudinal means in the direction of movement of the vehicle, i.e. along the length of the vehicle. Transverse means perpendicular to the longitudinal direction, i.e. along the width of the vehicle. The figures are for explaining only and not drawn to scale.

The invention deals with a public transport vehicle, that can move along fixed and/or predetermined routes for predetermined prices. The public transport vehicle has units for the flexible transport of passengers and/or freight. Such a unit can have different configurations, depending on whether it is laid out for the transport of passengers or freight. The vehicle can have a combination of units configured for freight and of units configured for passengers. The conversion from one configuration to another depends on the demand for freight or passengers. Such demand can be predicted using a reservation system and/or it can be based on past experience. Vehicles comprising such flexible convertible units thus provide optimal flexibility for the operators of such vehicles. Such units typically have a length of about 3 m, but different lengths from 2 m to 5 m are also possible. The width of the unit depends on the vehicle. Trains typically have a width of between 2.5 and 3.5 m, metros and light rails slightly less and busses 2.65 m or less.

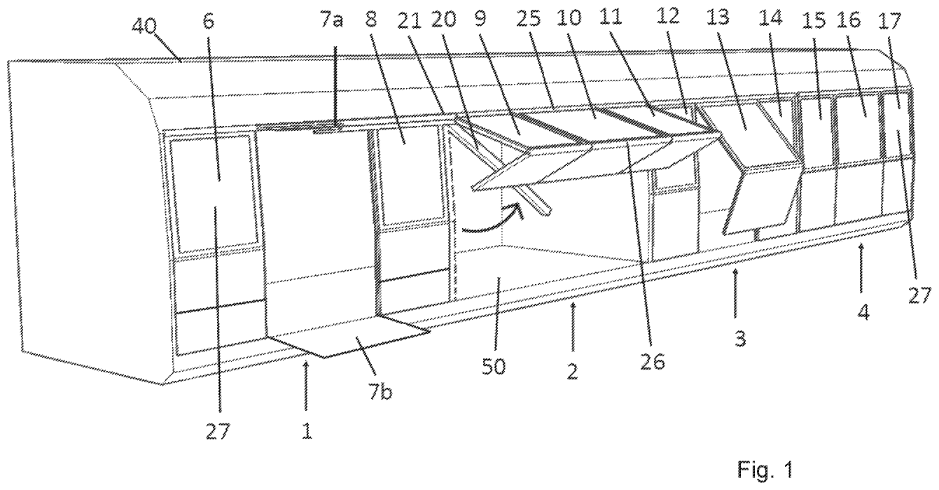

FIG. 1 shows an outer side wall of a public transport vehicle with four units 1, 2, 3, 4 with each unit having multiple adjacent doors that cover the side wall, in this case 3 doors (6, 7a, 7b, 8), (9, 10, 11), (12, 13, 14) and (15, 16, 17) per unit. Of course, other numbers of doors can also be used and/or doors of different sizes within a unit. Furthermore, several types of doors can be used for the multiple doors of a unit. For instance, doors can be of the up and over type (tipped doors) like those used for a garage door. Those doors then slide under or over the roof of the vehicle. In a favorable embodiment shown in FIG. 1 the doors are wing doors, also called gullwing or falcon doors. Those doors have hinges 25 at their top, i.e. just under or partially in the roof as indicated for the opening door 10 of unit 2. In FIG. 1 all doors have such hinges 25. Having hinges 25 at the top means wing doors remain outside the unit and thus when opened do not need to be stored under or on top of the roof. Wing doors can be constructed in a compact way, for instance by providing them with extra hinges 26, also indicated for door 10. In FIG. 1 all doors have extra hinges 26. With wing doors it is also possible to give the vehicle the look of a passenger vehicle. This is preferable, since it is not beneficial to the passenger experience if the vehicle looks like it was designed for freight. Passengers do not like to use a vehicle that looks like a freight vehicle. For this purpose the wing doors can have windows 27 like a normal passenger vehicle has. In FIG. 1 all doors have windows 27. The extra hinges 26 can be provided for instance underneath the windows 27 as shown in FIG. 1. It is clear from FIG. 1 that although the vehicle can transport flexibly freight or passengers in different units the outside look of the vehicle is clearly like a passenger vehicle. The vehicle looks like a conventional passengers vehicle, but with the added benefit of compact wide opening doors. As an extra benefit wing doors provide coverage against rain when opened as shown for unit 2. The doors of a unit are adjacent doors. This means all doors of a unit fit together without the use of supporting pillars between the doors. These doors are typically provided with at least 3 point locks. This means the doors can lock together along both sides of the door, but also along the bottom of the door. This means all sides of a door that have no hinge are provided with a lock. The side walls can be locked to an adjacent door or to a side of the unit or to a pillar 20 between units. The bottom of the door can be locked into the floor of the unit. In principle it is advantageous to also have every part that has a hinge provided with a lock. Such locks can be pins that slot into holes. The locks open up the possibility for choosing the door configuration of the outer wall, i.e. which doors will open and which ones will remain closed.

Unit 1 is a passengers unit, where door 6 and 8 are permanently closed and door 7a, b is used by passengers to enter or leave unit 1. In unit 1 doors 6, 7 and 8 are further divided. To facilitate loading of freight or the entry or exit of passengers it is advantageous if a bottom part 7b of a door 7 can fold downwards to provide a step for easy entry/exit and for covering a gap between a loading platform and the vehicle, so that a horizontal bridge is created between the vehicle and the platform. This means the bottom part 7b of a door is when opened not connected to the top part 7a of the door 7, but functions independently of the top 7a of the door. Such a bridge is especially useful for passengers using a wheelchair or mobility scooter. The door part 7a and b are locked together when the door 7 is closed.

Unit 2 is a freight unit. Here all doors 9, 10 and 11 can open simultaneously to provide a wide entry opening for freight. FIG. 1 shows that between unit 1 and 2 there is a removable pillar 20. In case there is no internal separation wall between units 1 and 2 this opens up the possibility to create even larger units when the pillar 20 is removed. It is for instance possible to provide a hinge 21 at the top of the pillar 20. The pillar can be fixed, i.e. locked in the floor when the vehicle is moving. Doors 8 and 9 are then also locked with the pillar 20. With the removable pillar 20 unit 1 and 2 can then form an extra-large unit for transporting even larger freight, i.e. freight longer than one unit. In FIG. 1 the doors 9, 10, 11 are locked together along their side walls, so that they can be opened as one door.

Unit 3 is also a passenger unit, where doors 12 and 14 are permanently closed and door 13 is opening to let passengers get in or out of the unit. In this unit 3 the doors 12, 13, 14 are not further divided in a top and bottom part as shown for doors 6, 7 and 8.

Unit 4 has all doors 15, 16, 17 closed. The unit would be like this when moving. This unit 4 could be either a passenger or a freight unit.

When the unit is meant for transporting freight, as unit 2 in FIG. 1, all doors in the side wall can open to provide an opening as wide as the length of a unit 2. The whole space of the unit 2 is than accessible for freight. In that case it is easy to transport a freight module or one or more containers in the open space of the unit. When all doors are open it is also possible to provide a passenger module with chairs, couches, tables or a toilet group in the open space.

An extra benefit can be obtained if both outer side walls of the unit are provided with the doors. That way loading and unloading of freight and/or passengers can take place even faster. Of course this requires appropriate loading places, like platforms on both sides of the vehicle. In case of passengers this also has the benefit that in case of a pandemic, flows of in- and outgoing passengers do not have to mix, so there is less risk of contamination since passengers do not have to face each other. Such vehicles can also be used as bridges between platforms when doors in both side walls of a unit are opened.

When using the unit for transporting passengers, like units 1 and 3, it is important for safety reasons to keep the doors close to passenger seats closed and locked to prevent persons or their belongings falling out when the vehicle stops or to prevent injuries of persons or their belongings getting stuck between doors. As long as passengers are transported those doors remain permanently closed and locked. Passengers do not have the authority to unlock these doors unless this is part of an emergency procedure. At least one door should be able to open to let passengers enter or exit the unit. In FIG. 1 all doors are shown with the same size, Of course it is also possible to have doors with different sizes, like a larger middle door and smaller doors next to this middle door. It is also possible to have a different number of doors.

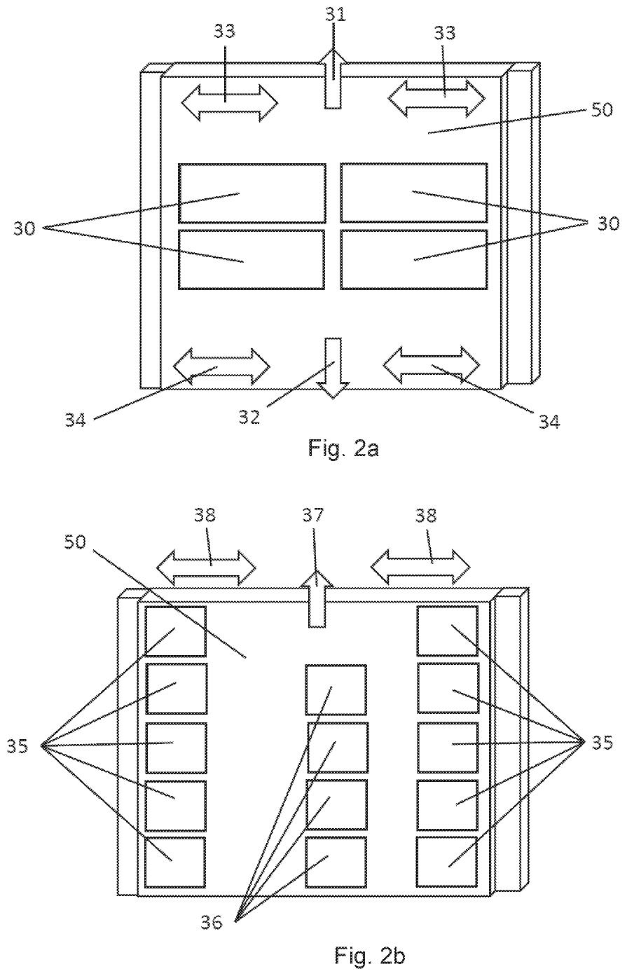

In practice an operator will choose a configuration for the passenger unit that is often used, like a first or second class configuration depending on the size of a unit. FIG. 2a, b shows two possible configurations that could apply to units 1 and 3 of FIG. 1. FIG. 2a shows a passenger unit with four modules 30 for couches 60 that are placed back to back. This passenger unit has doors in both side walls. Here the arrows 31-34 represent doors. The outgoing arrows 31 and 32 represent a door that can open to let passengers in or out. These doors can be seen in FIG. 1 as doors 7 or 13. The doors 31 and 32 are not close to the modules 30 for the couches 60 so that there is no danger of passengers or their belongings getting trapped or falling out of the doors. The doors 33 and 34 are closed. They stay permanently closed when the unit is used for transporting passengers. In FIG. 2b another configuration is shown. Here there is only one side provided with doors 37, 38. The door 37 is used for letting passengers in or out of the unit. The doors 38 remain permanently closed while transporting passengers. The unit of FIG. 2b has ten individual chairs 35. Some of the chairs 35 are provided with tables 36.

It should be clear that a vehicle according to the invention has far more doors available than in conventional vehicles. Conventional vehicles often have one door for more than 50 passengers. The configurations of FIG. 2a, b provide a door for 10 passengers or less. So it is possible to get passengers in or out of the passengers unit much quicker. In case of an emergency like a fire or an accident passengers can also get out much quicker. This can even be improved by opening all doors in case of an emergency. All doors should have autonomous safety measures when opening and closing utilizing camera, laser or lidar technology in order to assure the safety of passengers.

It is advantageous when more than two units are used, that units for freight (F) are in adjacent units or units for passengers (P) are in adjacent units. This means for instance when there are three units available, configurations should preferably be FFP or PPF. For six units this could be FFPPFF or FFFPPP. This has the advantage that movements of freight and passengers can be separated easily and there is less chance of a passenger getting injured or hindered by loading or unloading of freight. This is not shown in FIG. 1. Preferably the loading and unloading of freight and getting in and out of passengers should be physically separated for safety.

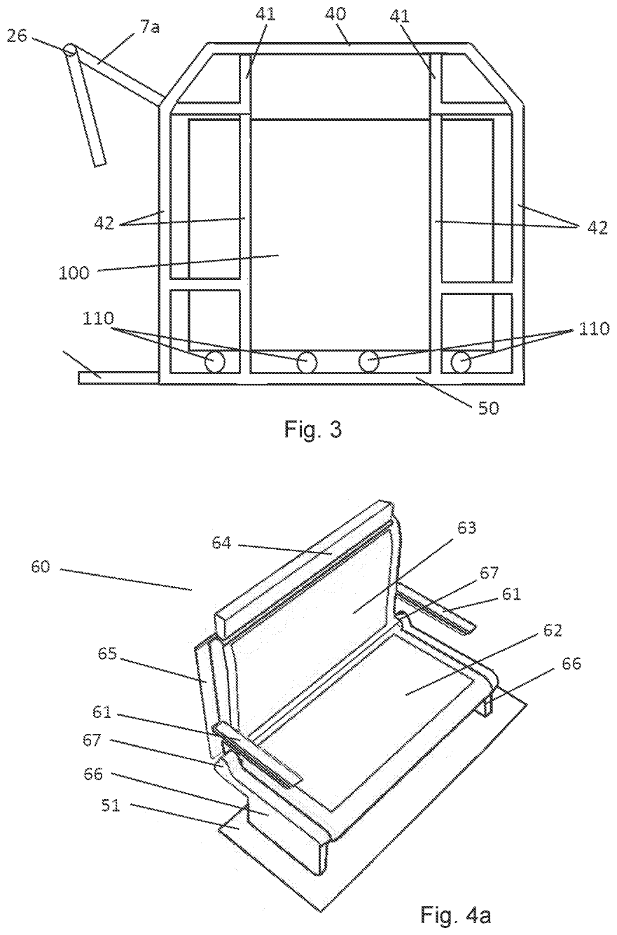

The possibility of creating a wide opening, spanning the whole length of a unit, brings extra construction challenges for the roof because of the wide open span and the weight of the doors. FIG. 3 shows a view from within a unit into a freight unit, where the units are provided with doors on one side. Inside the freight unit a freight container 100 provided with wheels 110 is visible. The units 1-4 are provided with a luggage rack 41 that spans the length of the roof 40 and strengthens the construction of the roof 40 of the unit at the side of the doors 7. This means that the luggage rack 41 is permanently fixed to the roof and its construction is used to add strength to the roof 40. This way the luggage rack 41 serves two functions, one to store luggage and two to provide strength to the roof 40. Of course it is possible to provide luggage racks 41 on both sides of the unit as shown in FIG. 3, even if doors are only provided on one side.

FIG. 3 also shows how the vehicle can be reinforced in between units and in between a unit and the front or back of the vehicle. It is advantageous that the unit is reinforced by providing a support structure 42, where the structure 42 is located in between units or in between a unit and the front or back of the vehicle. The support structure 42 shown in FIG. 3 comprises tubes that are welded together and run along the sides, roof and floor of the unit. The outer tubes can also serve to lock doors of units. Thus a very strong structure 42 results. It is also possible to use a more box like structure, where the side walls of the box provide strength. Thus such a support structure 42 does not affect the space in the unit, since it is located outside the unit in the space between two units or between the unit and the front or back of the vehicle. Especially when it has a box like shape, the support structure 42 can also be used for accommodating support systems, like air treatment or a toilet. For an optimal use of the vehicle, the space between units should be relatively small as compared to the space within the units, so that the vehicle can be most efficiently used for transport of freight and/or passengers in the units.

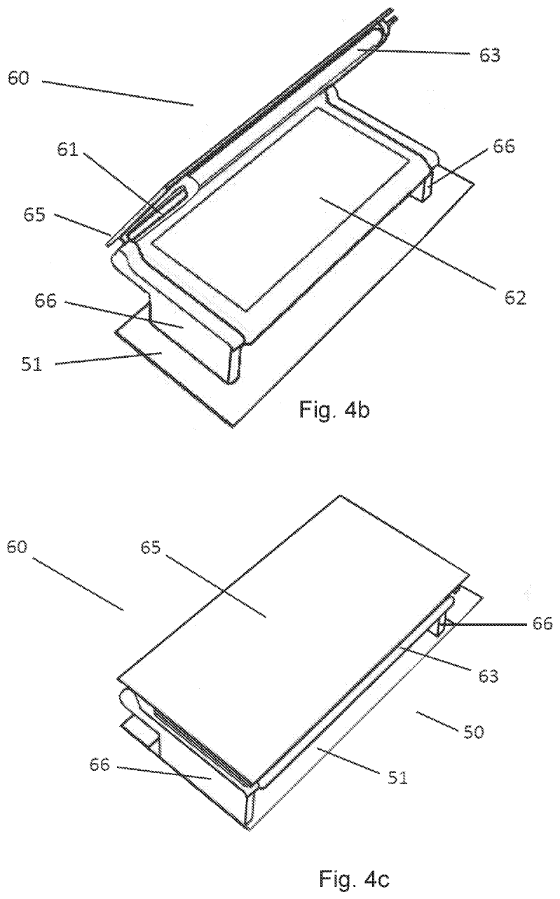

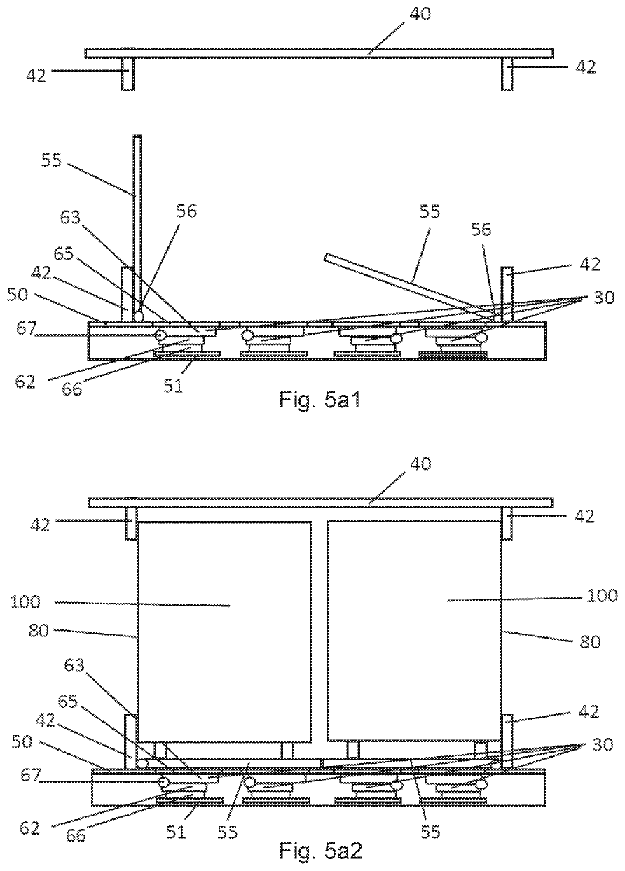

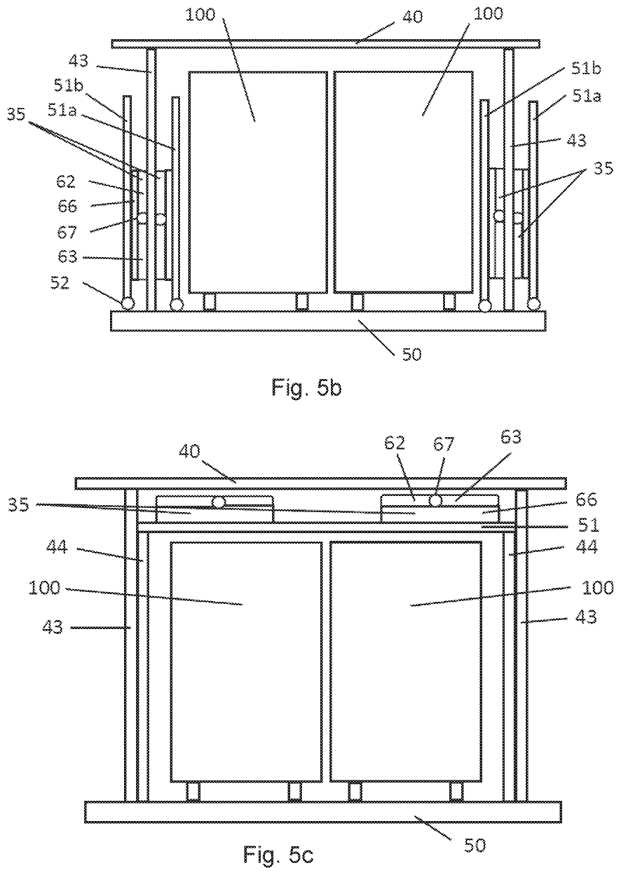

FIGS. 2a and b show how the floor 50 of a unit is divided in checkerboard fields with fields 30 for couches 60, with chairs 35, or tables 36, where each field can comprise a piece of furniture. FIGS. 4a, b, c show how such a piece of furniture 60 can be folded to form a small package. FIGS. 5a1, a2, b, c show how such folded furniture can be stowed away either in the floor (FIG. 5a), in a space between the units (FIG. 5b), or against the roof 40 (FIG. FIG. 5c), so that the top of the floor 50 is free of furniture and practically flat when the furniture is stowed away. This way no special passenger module is needed. When the unit is used for transporting freight the furniture for passengers is stowed away. The flat floor 50 can then be used for transporting freight, for instance by placing containers 100 in the unit. The furniture can comprise chairs and/or tables, but can also comprise couches, waste baskets, or toilet units. In general all furniture used in a vehicle can be used. Such furniture can also be provided with accessories, like USB recharging contacts or heating or cooling possibilities. For larger furniture, like a couch or a toilet unit more than one checkerboard field or a larger field can be used. Preferably the furniture for each checkerboard field can be individually chosen to be a chair, table or the field can be left free to make different configurations of furniture in the unit possible. That way flexibility is increased even further. For a first class configuration with more space, a row of chairs can be left in the floor for more leg space. It is also possible to provide each chair with a table. In a second class configuration, all chairs can be used. To use the space inside a unit in an optimal way, it is also possible to put a rotation mechanism in each chair so that also back to back configurations of chairs are possible. In case of a pandemic, chairs can be separated by one or more tables to make sure that chairs are not located next to each-other and they can be rotated so that passengers do not sit face to face. The furniture can be folded in different ways. For instance it can be folded like a camping or beach chair so that the space occupied when folded is small, but I can also remain intact when space is not an issue. FIGS. 4a, b, c show a possible way to fold a couch 60 in a checkerboard field 30 as shown in FIG. 2a. FIG. 4a shows a couch 60 with arm rests 61. Such a couch can seat 2 or 3 passengers depending on the size of the couch 60. The couch further comprises a seating area 62, a back rest 63 and head rest 64. The backrest 63 is provided with an extra backplate 65. Such a backplate 65 can contain a folding table for a passenger seated on the couch behind. The support legs 66 are drawn as solid, but the couch 60 can also made with foldable support legs 66. The couch 60 is provided on a top floor plate 51. This plate 51 typically is separate from the floor 50, so that the couch 60 with the top floor plate 51 can be stowed away (see FIG. 4c). The support plate 51 can comprise more than one piece of furniture. FIG. 4b shows the couch 60 in the half folded situation, where the headrest 64 is stowed inside the backrest 63. FIG. 4c shows the couch in a fully folded position, sinking into the floor 50. When fully sunk in the floor 50, the backplate 65 will form part of the floor 50. If the folded couch of FIG. 4c is not sunk into the floor a table can be formed by backplate 65 of a chair or couch. In that case the support plate 51 will be part of the floor 50.

FIGS. 5a1, a2, b, c show that furniture can be stowed away in different places. FIG. 5a1 shows that the folded couches 30 of FIG. 4 can be stored in the floor 50. FIG. 5a1 shows the situation that freight is not loaded. In this case there are four identical couches 30. The backplate 65 of the backrest 63 then forms a part of the floor 50. Of course this backplate 65 then needs to be strong enough and have enough support to be able to bear the weight of the freight. The backplate 65 can for instance rest on a supporting structure in the floor 50. FIG. 5a1 shows another option, where the floor 50 is strengthened with an extra floor 55. The floor 55 is an extra strong floor that is able to also bear heavy containers. This floor 55 has two parts that can be folded in the space between units when the unit is used for passengers. Therefore the floor 55 is provided with hinges 56, that allow rotation of floor 55. The left side of FIG. 5a1 shows the floor 55 located against the space between the units, the right side shows the floor 55 half rotated down. Such a floor 55 can also have more parts in a transverse direction. For instance it can be split in three parts, where the middle part can be left down when a passage between two passenger units is required, for instance for access to a toilet in the space between the units. FIG. 5a2 shows the floor 55 folded down and located on the floor 50. Now even heavy containers 100 can be loaded on the floor 55, 50. The floor 55 can be folded using conventional techniques, like hydraulics, pneumatics or electric motors. The containers 100 can be fixed by locking them to support structures, like 41 and 42.

Another example is shown in FIG. 5b where the furniture is stowed between units, i.e. in the transverse side walls of units. If there is enough space between units, furniture may not even have to be folded. FIG. 5b shows a different way of folding where the backrest 64 is folded back, so that the seat area 62 and backrest 63 are in line. This allows for an overall smaller thickness of the folded furniture. In FIG. 5b the support plate 51 is split in two 51a and 51b. Support plates 51a and b carry the furniture. Support plate 51a is folded against one transverse side wall, while support plate 51b is folded against the other transverse side wall. FIG. 5c shows how the whole floor unit formed by a single support plate 51 including folded furniture is stowed under the roof 40 of the unit. The lifting of the floor unit 51 with the chairs can be done with unit 44 schematically indicated in FIG. 5c. Such a lifting unit 44 can be activated with hydraulic or pneumatic lifting cylinders, but also electrically driven screw/bolt constructions or pulleys are possible. Of course it is also possible to have a combination of different places to stow furniture, for instance partly stowed in between units and partly in the floor.

When the furniture is stowed away it is possible to clean the furniture, for instance to kill bacteria and viruses by using a UVC lamp or diode, or by other ways to kill bacteria or viruses.

When using a complete vehicle in passenger or freight modus, i.e. all units are either passenger modules or freight modules, there is no problem of a separation between passenger and freight unit. When a vehicle has several units and some are for freight, while others are for passengers it is important to separate the freight and passenger units. This can for instance be done by providing a roller shutter in the roof or floor between units. It is also possible to have a fixed wall between units. Such a wall can be provided with a door if desired. In FIGS. 5b, c such a wall 43 is shown. FIG. 5a shows that preferably for transporting freight, closed containers 100 are used that comprise a side wall 80 that can function as a separation between units with passengers and units with freight. In FIG. 5a the supporting structure 42 is used as an enclosure for the side wall 80 of containers 100. The containers 100 fit closely against the structure 42. This has several advantages. In a public transport vehicle closed and locked containers, i.e. with all side walls present, are preferable. Of course the container should have at least one loading door, that can be closed and locked. This means there is no risk of freight falling out and injuring passengers. Moreover the risk of theft or damage to freight by passengers is minimal. The side wall 80 of a container 100 can then also be used to separate passengers in a passenger unit from freight in a freight unit. In that case the separation in the form of roller shutters or a separation wall 43 is not necessary anymore.

It is also important that on the outside of the vehicle an indication tells passengers which units are available for passengers and which are reserved for freight. This outside indication can also tell passengers on the platform how many seats are available in a certain passenger unit. For instance, a color red can be used to indicate a freight unit, a green color for free second class passenger units and blue for first class passenger units. The outside indication can be mirrored on the platform, so that passengers can align and freight can be placed at the right places to make a quick loading and unloading of units possible.

Preferably the public transport vehicle is a rail vehicle, like a train, light train or metro, or road vehicle, like a bus. In many cases these forms of public transport are very crowded with passengers during the morning—and evening rush hours in weekdays, but during the rest of a weekday or in the weekend only a fraction of the passenger capacity is used. During the rush hours most units in such vehicles can be used for transporting passengers. During the off rush hours, conversion of many units to transporting freight can take place. That way public transport vehicles can be used much more efficiently resulting in significant higher utilization rates and revenues as compared to just public transport of passengers.

This makes it possible to stimulate the use of public transport through numerous quantitative and qualitative impulses such as reducing the fees for public transport or even making it completely free of charge. Moreover, in most cases public transport has a fine-meshed network of rails or of bus lanes that is often exclusively reserved to only them and in general reaches into the heart of crowded cities. If such a network can be used more extensively for the transport of freight as well, this means a significant decrease of trucks and delivery vehicles on roads and in(to) cities which will lead to a significantly reduction of congestions. It is also possible to make public transport to distant isolated villages profitable by combining freight and passenger transport. Moreover public transport vehicles often have electric powertrains, thus further reducing harmful emissions such as CO2, NOx and PM10. In case public transport vehicles have fossil fueled powertrains, the inventive vehicle may initiate and accelerate energy transitions from fossil fueled powertrains to more sustainable electric of hydrogen powertrains because of its significant cashflow abilities resulting from the significant higher utilization rate.

1. A public transport vehicle comprising at least one unit for the flexible transport of passengers and/or freight, characterized in that at least one outer side wall of the unit has multiple adjacent doors, that also form the outer side wall of the vehicle along the length of the vehicle, where when the unit is used for freight transport all doors can open to provide a wide entry opening for loading and unloading freight and when used for passenger transport one or more of the doors remain permanently closed and at least one door can be opened.

2. The public transport vehicle according to claim 1 with more than two units, characterized in that units for freight are in adjacent units or units for passengers are in adjacent units.

3. The public transport vehicle according to claim 1, characterized in that the doors are wing doors.

4. The public transport vehicle according to claim 1, characterized in that both outer side walls of the unit are provided with the doors.

5. The public transport vehicle according to claim 1, characterized in that the unit is provided with a luggage rack that spans along a length of the unit and that strengthens construction of a roof of the unit at the side of the doors.

6. The public transport vehicle according to claim 1, characterized in that the unit is reinforced by providing a support structure, where the support structure is located in between units or in between a unit and a front or back of the vehicle.

7. The public transport vehicle according to claim 1, characterized in that a floor of the unit is divided in checkerboard fields, where each field can comprise a piece of furniture that can be stowed away either in a space between the units, or against a roof or in the floor, so that a top of the floor is free of furniture and practically flat when the furniture is stowed away.

8. The public transport vehicle according to claim 7, characterized in that the furniture comprises chairs and tables.

9. The public transport vehicle according to claim 8, characterized in that the tables can be formed by the backrests of chairs.

10. The public transport vehicle according to claim 7, characterized in that the furniture for checkerboard fields can be chosen to be a chair or table to make different configurations of furniture in the unit possible.

11. The public transport vehicle according to claim 1, characterized in that a bottom part of a door can fold downwards to provide a step for easy entry/exit and for covering a gap between a loading platform and the vehicle.

12. The public transport vehicle according to claim 1, characterized in that for transporting freight, closed containers are used that comprise a side wall that can function as a separation between units with passengers and units with freight.

13. The public transport vehicle according to claim 1, characterized in that the public transport vehicle is a rail vehicle or a bus.
